(19) United States
(12) Patent Application Publication
(10) Pub. No.: US 2006/0010042 A1
(43) Pub. Date: Jan. 12, 2006

(54) Purchasing and inquiring method through label capturing cellular devices

(76) Inventors: Alejandro Javier Gianakis, Martinez (AR); Julian Fernandez, San Justo (AR)

Correspondence Address: INTELLECTUAL PROPERTY BUSINESS CONSULTANTS, PLLC, 1413 SANTA CRUZ AVENUE, CORAL GABLES, FL, 33134, US

(21) Appl. No.: 10/883,682

(22) Filed: Jul. 6, 2004

(51) Int. Cl. G06Q 30/00

(52) U.S. Cl. 705/26

(57) ABSTRACT

A method for capturing a standard label, such as bar code, RF, or similar, analyze and decipher it utilizing a mobile station device with label capturing means, such as a video camera or RF receiver; exchanging the captured label information and other user input preferences with one or more remote servers via a cellular network; retrieving information related to the captured label to furnish the mobile station device's user the options of inquiry or purchase from previously designated merchants. When the mobile station device is equipped with a video camera, it utilizes a resident software program to decode the video camera captured image and identify it as a standard bar code label. The mobile station device communicates preferably via the data channel, on cellular transmissions protocols that use such feature, with a cellular network, which in turn may use standard telephony or internet to connect with a remote server. Another feature is a method to induce a purchase or an inquiry by contacting a mobile station device with promotional information and enabling its user to realize a purchase or an inquiry.

### BACKGROUND OF THE INVENTION

1. Field of the Invention

This invention generally relates to a method for capturing, analyzing, and deciphering a label, such as a bar code label, exchanging information with a remote data bank, and effecting a transaction based on such information. More particularly, this invention relates to a method of processing bar code labels by means of a cellular device equipped with video capturing means to capture an image, natively processing the captured image, identifying the captured image as a standard bar code label, exchanging information pertaining to the label with a remote server, displaying remote server's prearranged audiovisual data on the cellular device display screen, and allowing the user to realize a transaction based on the displayed data.

2. Description of the Related Art

Inventory management has greatly benefited by the incorporation of bar code labels that have become ubiquitous in almost all products and many services placed in the stream of commerce. Bar code labels are used today to uniquely identify a particular product and match it, through a database, with its characteristics. Bar code label technology enables members of the distribution chain, from manufacturer to retailer, among other things to monitor inventory levels, determine reordering points, allow for innovations such as just-in-time manufacturing and supply, and raise the general level of efficiency of their operations. Bar code labels are critical elements for conducting business in today's global economy. Bar code labels are used not only to identify discrete products, sold in units or multiples thereof, but also on products sold by other measuring units, such as by weight, by length, by time, by volume, or by a combination thereof.

Since its inception bar code label technology has evolved as well, and the name today encompasses not only the original intercalated parallel bars of varying widths arranged at various distances from one another but a variety of graphic arrangements, that are well known to the person skilled in the art, that can be illuminated with a coherent light source, and its reflection captured and deciphered as bar code labels. Bar code technology encompasses graphic representations that encode data to be scanned, the printing, technologies that produce machine-readable symbols, the scanners and decoders that capture images of the graphic representations and convert them to computer-compatible digital data, and the verifiers that validate graphic representation quality.

The utilization of bar code label technology has been expanded to other users beyond the distribution chain, including corporate and individual users who desire to tag property for inventory purposes. Bar code labels are used not only on products but also in a myriad of forms such as, but not limited to, printed lists, newspaper and brochure advertisements, and web sites.

Radio Frequency (“RF”) labels have recently appeared on products to add a functionality that bar code labels lack, namely the remote reading of products so labeled. RF labels transmit a unique code that can be read at a distance by a RF receivers thus greatly reducing the need to physically conduct an inventory of each item in stock. In contrast to RF labels, a person or machine must individually scan bar code labeled products at short distances.

Until today the benefits of inventory labels, whether bar code or RF labels, benefited members of the distribution chain however systematically excluded the ultimate consumer of the product, particularly the retail consumer. This exclusion is motivated primarily because standard label capturing devices are costly; they lack portability, and the devices that could capture labels could not provide useful options for customer action, such as realize a purchase. The solutions so far implemented by retailers are costly and inefficient and invariably include a plurality of manned check out counters, equipped with fixed label capturing scanners, usually backlogged by long lines of customers attempting to conduct all inquiry or a purchase. This part of the business, well known by the person skilled in the art, is known as front desk. The cost of managing the front desk can be a significant part of the cost of running a business and it is passed along to the final consumer. A method that could reduce or eliminate front desk operations will not only reduce overall business costs but could integrate seamlessly the customer into the manufacturing, inventory management, and distribution chain.

Another technology that emerged recently is cellular telephony. The rapid absorption by the general public of cellular telephony opened a new era to allow persons to communicate with one another without depending on a physical, landed, connection. Recent developments in cellular telephony, primarily due to the development of digital signal processing circuitry, enabled cellular telephones to transmit not only voice but also data.

Today, a variety of mobile station devices (“MSD”) incorporate cellular telephony. The MSD, used in these communications, have proliferated to include a plethora of artifacts including, as an example and not as an exhaustive list, telephones, electronic organizers, personal digital assistants, internet appliances, wristwatches, combinations of the previous devices, and others well known to the person skilled in the art. This data transmission capability permits today's MSD users to access internet services and interchange data with remote computer servers.

Another recent development in MSD came available with the incorporation of video camera devices integrated into MSD. These MSD can capture an image of whatever is located within the focal point of the camera lens; process the captured image including compressing it, and transmit it in a standard format through the cellular network to another MSD or through the network to another device, such as a computer. To process a captured image cellular telephones have built in native processing capabilities allowing the MSD to store software code that can process data in response to user input without external help from the cellular network.

Some of today's cellular transmission protocols include, as examples but not as an exhaustive list, Global System for Mobile (GSM), Generalized Packet Radio System (GPRS), High Speed Circuit Switched Data (HSCSD), Bluetooth, and Wireless Application Protocol (WAP). These transmission protocols include a channel of communication, called control channel, used by the cellular communications provider to transmit and receive instructions between the MSD and the cellular network provider. The control channel is active from the moment a MSD handshakes the cellular network and until it is deactivated. Most cellular network providers charge for MSD connection time, so the cumulative cost of on line connection could be onerous. The transmission of data through the control channel occurs independently of whether the user has established a communication channel with the network; the only requirement is that the user activates the MSD. In addition to the control channel, these protocols provide a voice and a data channel whose functions are homonymous.

MSD communicate with one another or with fixed network stations through a variety of means and transmission arrangements. These means are well known to the person skilled in the art and include, but are not limited to, radio frequency (RF) transmissions in a plurality of spectra, infrared, laser, and others well known to the person skilled in the art. The transmission arrangements include, but are not limited to, cellular, satellite, MSD to MSD, wireless, and others well known to the person skilled in the art.

### SUMMARY OF THE INVENTION

The present invention overcomes the foregoing and other shortcomings of front desk operations and lack of integration of the consumer into the distribution chain, by providing a system and method to furnish label-capturing capabilities to existing MSD and further providing the means to allow interactive transaction capabilities to standard MSD interconnected to remote transaction servers.

In accordance with one aspect of the present invention, a MSD user initiates a transaction activity by enabling a MSD and activating its operation through a proprietary MSD resident software program, through either an icon or a keyword. The MSD resident software program presents the MSD user with a series of options, chiefly among them one or more merchants with whom the MSD user wishes to realize a transaction. The MSD resident software program prompts the user to select from a variety of functions, including but not limited to, inquiries, purchases, drafting or editing shopping lists, or capturing labels. User inquiries may include questions specifically related to the selected merchant's current offerings or of comparative nature with other merchants' offerings of similar products. User purchase options may include in store pick up or delivery options according to the selected merchant's capabilities. Additionally, the purchase options' menu may include a variety of forms of payment according to the select merchant's capabilities.

The MSD user may be prompted by the resident software program to draft a new list of products about which desires to carry out a transaction, or may also retrieve a previously drafted product list and modify it. The shopping list may include products offered for sale by units, by weight, by volume, by length, or a by combination thereof, according to the selected merchant's offerings.

Depending on the label capturing capabilities of the MSD, its user may acquire a label, such as, for example and without limitation, a bar code label or a RF label. The label capturing means of the MSD may include, but it is not limited to, video camera, RF receiver, infrared receiver, laser scanner, and others well known to the person skilled in the art.

As an example, and without limitation, should the MSD user desire to acquire a bar code label utilizing the video camera capability of the MSD, the process may be as follows. Initially the MSD user will activate on the MSD a resident software program, which in turn will provide the user several interface options. Among the options offered to the user may be the selection of one or more merchants with whom an inquiry or a purchase may be transacted. Alternatively, the user may elect to capture a product label and then request a list of merchants that may be offering such product. The user may capture a bar code label from anywhere including, but not limited to, product packaging, newsprint advertisement, brochures, or websites; thus, it is not necessary that the user be physically at a merchant's place of business, just that it has access to a labeled product so it can be captured with a MSD equipped with label capturing means. Subsequently, the MSD resident software program will enable the video camera function of the MSD to capture an image of the label disposed in front of its video camera lens. The display screen of the MSD may be utilized as a viewfinder to determine whether the bar code label to be captured fits in its entirety within the capturing angle width of the video camera lens. A partially fitting bar code label will later be decoded partially and the resident software program will report a label capturing error to the MSD user. After the MSD user makes the proper adjustments to ensure full capture of the bar code label, the user triggers the capture of the image of the bar code label. Utilizing the MSD's processing capabilities, the MSD processes the captured image and deciphers it to determine whether the captured image corresponds to one of the standard bar code labels. The MSD resident software program then informs the user of the success or failure of the operation.

As another not limiting example, should the MSD have a RF receiver capability, it may be used to acquire an RF label. In that case the MSD resident software program will perform some of the following steps, including but not limited to, enable the RF receiving device on the MSD, capture the RF signal from the selected product, natively process the captured RF signal, determine whether the captured RF signal corresponds to an RF label standard, and inform the user of the success or failure of the operation.

Once the label-capturing task is accomplished, the resident software program may prompt the MSD user with a plurality of options. In the background, the MSD resident software program may communicate with one or more remote servers. The communication between the MSD and the remote servers is accomplished preferably utilizing the data channel of the MSD, although it may also utilize the control and voice channels. The use of the data channel of a MSD to transmit and receive data, instead of the voice channel, is important because in that manner the MSD user does not incur communication charges, which can be onerous. In places where unlimited cellular telephony does not incur a per minute charge, i.e. it is provided at a fixed cost, the use of the voice channel may be a transmission option. When using a voice communication channel, safeguards, well known to the person skilled in the art, should be applied so no to corrupt a data stream, such as when a MSD user's places or receives a voice call. Upon receiving the MSD user's selected options, the remote servers will authenticate the transmitting MSD and format all information to be exchanged to its specific technical capabilities. For example, the remoter server may customize the data sent in function of the display characteristics of the MSD's screen, such as partitioning it in one or more windows to display text, audio, still pictures, and/or video.

The ability of the remote servers to customize the display screen of the MSD is important because it may be used to send data in different formats, such as text, audio, still pictures, video, or a combination thereof, to different areas of the display screen. Furthermore, the ability to partition the display screen into separate windows enables the server to transmit independent data to each window. Some of these windows may be used to provide responses to the MSD user request, yet others may be used for displaying advertisement from the merchant or third parties, or to allow for other functions of the MSD.

In accordance with another aspect of the present invention, the MSD resident software program has the native ability to decipher a bar code label from an image captured by the video camera of the MSD. The MSD resident software program process the captured image according to a proprietary algorithm to match a pattern that corresponds to one of the standard bar code labels. When the resident software program deciphers the image and matches it to a bar code label standard it reports to the MSD user and sends the deciphered image's data to the remote server; when it fails to match the captured image with a standard bar code label, it reports to the user for a recapture operation.

In accordance with another aspect of the present invention the remote server may send unrequested data to the MSD for audiovisual display. The unrequested data may be one or more merchant advertisements. The sending of the unrequested data may be triggered by the physical location of the MSD in relation to a merchant's place of business, a particular time, date, or holiday, or a follow up on a previous purchase or inquiry. The MSD user may respond to the unrequested data by conducting an inquiry, a purchase, or nothing.

In accordance with another aspect of the present invention, the remote servers may have resident information, which may be updated from time to time or continuously, from one or more merchant's servers and may include in its transmission to the MSD helpful information related to the MSD inquiry. The remote servers may send the MSD formatting instructions customized to its technical specifications such that it can display on the MSD screen advertisement related to the inquired products or to different products related to the user's inquiry.

In accordance with another aspect of the present invention, the MSD resident software program may be customized for the processing capabilities of each MSD, such that it can carry out the tasks of activating the label acquiring means of the MSD, provide for the drafting and modification of user lists, operating transparently through the data channel of the MSD, and format the MSD display screen.

In accordance with another aspect of the present invention, the MSD resident software program may have the capability to decipher an image that it is not a standard bar code label but it is nevertheless a label designed by of for the merchant's sole use.

In accordance with another aspect of the present invention, the remote server may initiate contact with an active MSD. The remote server may utilize the data channel of a cellular network to send promotional information formatted to the technical capabilities of the MSD. The remote server contact may occur upon the triggering of certain parameters, such as, but not limited to, a particular date, time, or user related event, the proximity of the MSD to a merchant's place of business, a promotion or service accepted by the MSD user, and a recent transaction carried out by the MSD user. Upon remote server contact, an activated MSD with active resident software program may provide audiovisual communication to the user about a merchant promotion and may also provide an offer to purchase a product or service on the spot or at a later time. The merchant promotion may also be combined with a previously captured discount coupon or a similar promotion.

### BRIEF DESCRIPTION OF THE DRAWINGS

FIG. 1 is an embodiment of the system elements incorporating one or more MSD with label reading capabilities, a cellular network, an internet communications network, a remote dedicated server, and one or more interconnected merchant servers.

FIG. 2 is an embodiment of a MSD display screen presenting some initial user options.

FIG. 3 is an embodiment of a MSD display screen formatted by a remote server presenting multiple windows capabilities.

FIG. 4 is an embodiment of a MSD display screen formatted by a remote server into multiple windows depicting among other things streaming audiovisual messages, such as advertisements, another window streaming text messages, yet other window permitting user interface with a shopping list.

FIG. 5 is an embodiment of a MSD in the process of capturing a bar code label and its display screen presenting a captured bar code label.

FIG. 6 is a flowchart of one possible embodiment of the invention.

### DETAILED DESCRIPTION OF THE EMBODIMENTS

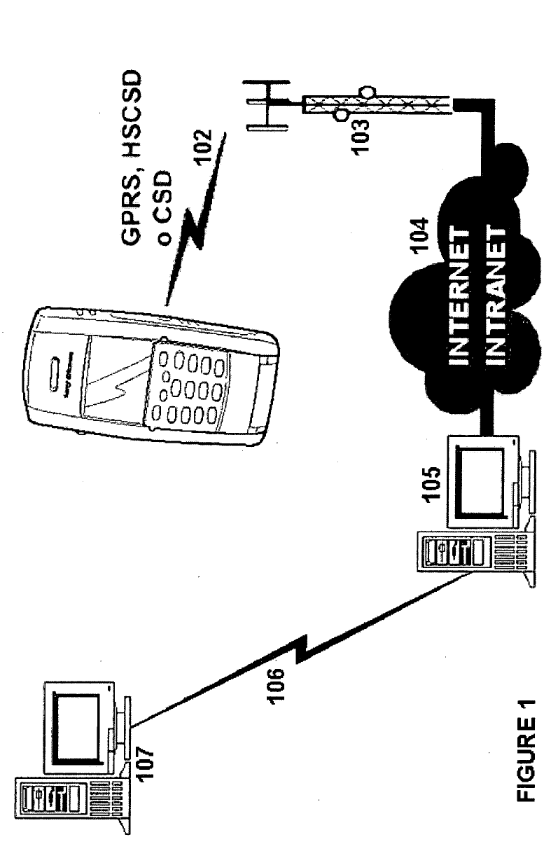

FIG. 1 is one embodiment of the system elements of the invention. This particular embodiment incorporates one or more MSD 101 with label capturing and native processing capabilities; a MSD resident software program, not shown, that interfaces with the user and coordinates MSD's functions such as label capturing means operations, label deciphering, data communications, display screen formatting, audio and visual data channeling to the display screen and speakers, and facilitate I/O operations; a cellular network 103 through which data communication of the captured and decoded label takes place; an internet communications network 104 or other telecommunications means through which the data is channeled to one or more remote servers 105 capable of processing MSD 101 transmitted data and, and one or more interconnected merchant servers 107. In the exemplary embodiment, a MSD 101 with label capturing means, such as a video camera for bar code labels or a RF receiver for RF labels, is utilized to interface with its user, process user's options, capture an image disposed within the label capturing means operating envelope, decipher it as a label, and transmit the deciphered data and user options. The MSD 101 communicates with a cellular network 103 preferably through its data channel 102, and through either the internet or a dedicated connection 104, it further communicates with one or more remote servers 105. The remote servers 105 exchange information with MSD 101 and update their own database by tapping on one or more merchant servers 107 through an internet or a dedicated connection 106.

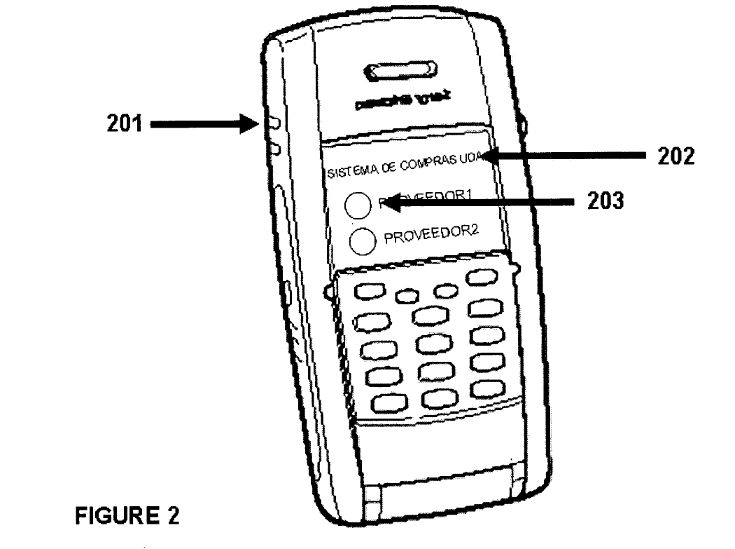

FIG. 2 is an embodiment of a MSD 201 display screen 202 presenting initial user options such as a plurality of merchants 203 with whom the user may realize a product or service inquiry or a purchase, drafting and editing user's shopping lists, defining user preferences for payment and delivery, and storing user's personal data such as address or credit card.

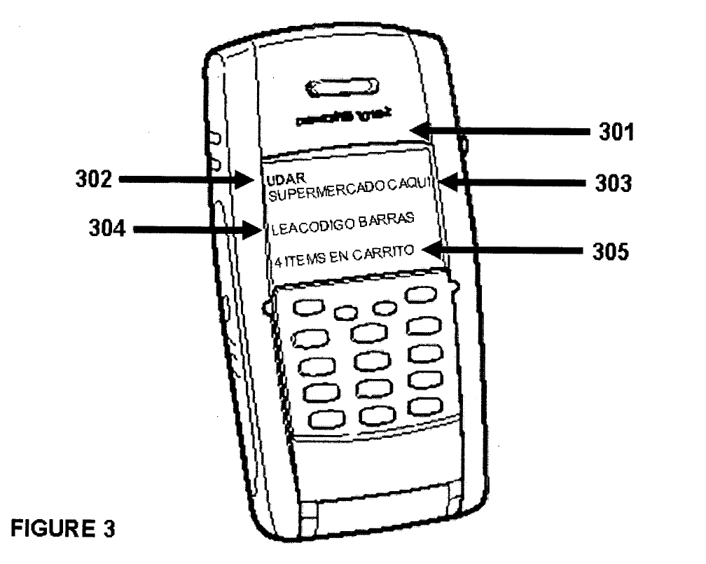

FIG. 3 is an embodiment of a MSD 301 display screen 302 formatted according to instructions sent by a remote server, not shown, presenting multiple windows customized according to the MSD 301 functional capabilities. The customized display screen 302 may be partitioned in one or more windows in which the remote server may stream different data customized to the user interests and may include, for example and without limitation, sections pertaining to user's personal information 303, merchant's welcome or other advertisement message section 304, and a list of current shopping or inquiry activities 305.

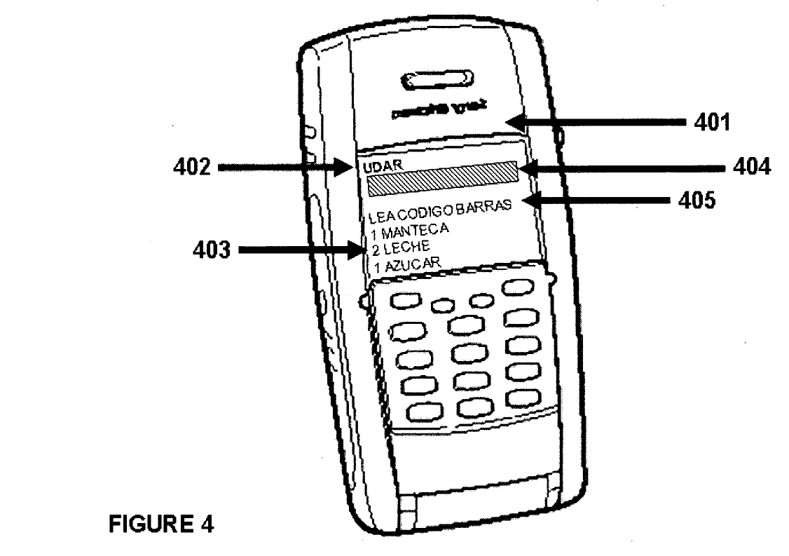

FIG. 4 is another preferred embodiment of a MSD 401 display screen 402 depicting a plurality of windows as formatted by instructions sent by a remote server, not shown, to the MSD's specific display capabilities. The MSD 401 capabilities my permit a remote server, not shown, to stream merchant's, competitor's, or third party's audiovisual advertisement, including still pictures and video, through a designated window 404 on the display screen 402. The audio portion of the data may be streamed through the earpiece, not shown, or other available speaker of the MSD. Additional display screen windows may simultaneously depict user's purchase or inquiry list 403, system-operating instructions 405, and allow user interface with the MSD resident software program.

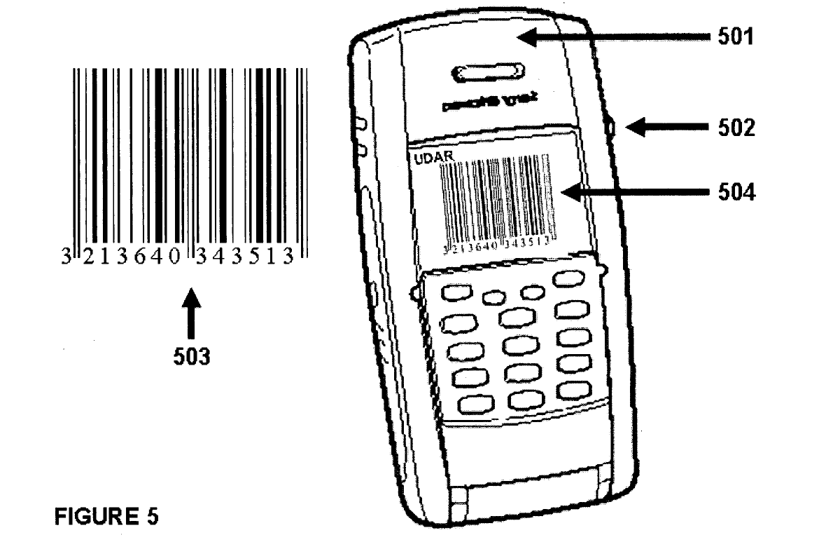

FIG. 5 is an embodiment of a MSD 501 in the process of capturing a bar code label 503. In the case where the MSD 501 is equipped with video capture means 502, the user points the capture means lens, not shown, towards the bar code label 503. The resident software program may facilitate the capture means lens positioning by presenting a window that operates as a viewfinder 504, as known by persons skilled in the art. The native processing capabilities of MSD 501 deciphers the captured bar code label 503, then converts it into digital data stream and sends it to remote servers, preferably via the data channel, for further processing.

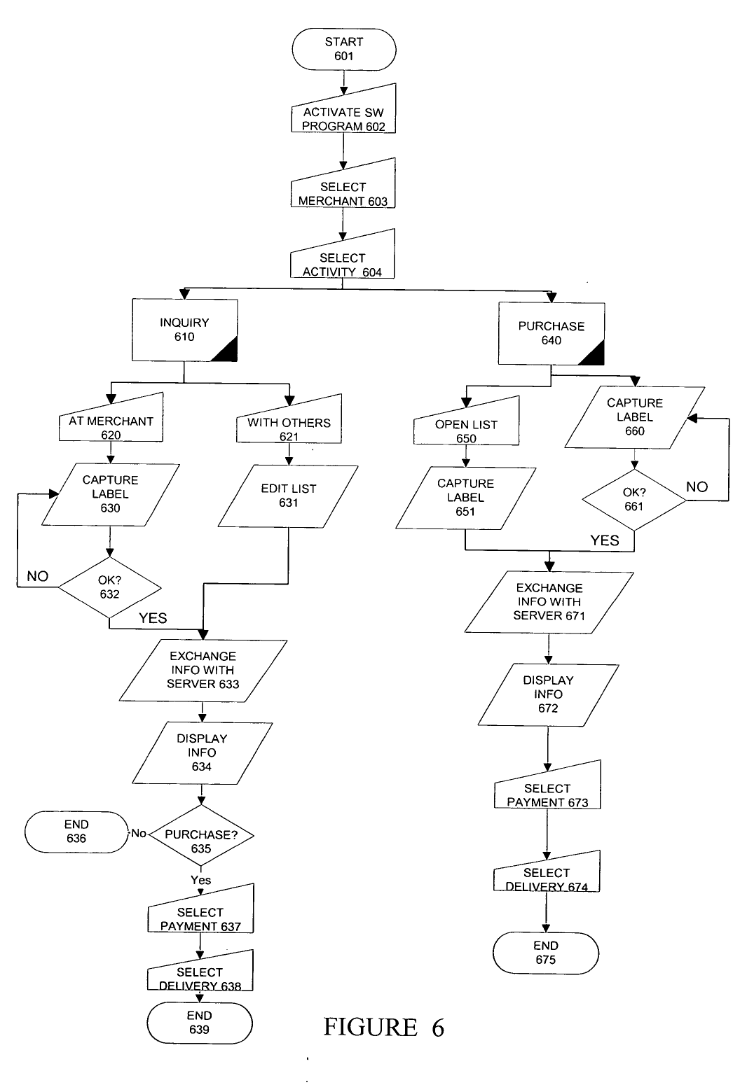

FIG. 6 is a flowchart of one possible embodiment of the invention. A user begins 601 by activating a MSD, equipped with video capturing means such as a video camera, and initiating a MSD resident software program 602 that will allow the user to interface with the MSD. In this particular embodiment, the MSD resident software program asks the MSD user to select a merchant 603 from list of merchants. The MSD resident software program will then request the MSD user to select what activity wants to carry out 604. Two activities may be transacted, an inquiry of a product or service's price, availability, or characteristics 610 or a product or service purchase 640.

If the MSD use desires to carry out an inquiry 610, the MSD resident software program will prompt the MSD user to select whether it would be with the selected merchant 620 or with various merchants for competitive information 621. The MSD resident software program will then inquire whether the MSD user wishes to capture a label 630, related to a product or service, or use a previously drafted shopping list 631. If the MSD user wishes to capture a label, the MSD resident software program will prompt the video capturing means of the MSD and inform the user when it is ready to capture a label. The MSD display screen may show a preview of the label for user approval in a graphic representation of a viewfinder. If the label captured is acceptable, i.e. decodable, to the MSD resident software program 632, it will continue with the next step, otherwise, it will inform the MSD use of the capture failure and request a new label capture. Once the MSD resident software program satisfactorily deciphers the captured image and identifies it as a bar code label, it begins exchanging information with a remote server 633 utilizing preferably the data channel of the cellular communications network. The remote server 633 authenticates the MSD, processes the data received from the MSD, responds to the MSD requests, and sends formatting instructions to the MSD such that the resident software program may format the MSD display screen according to its specific capabilities, including partitioning it into one or more windows. The remote server then sends to one of these windows the MSD user's requested information 634, and it may send to another window and to the device's speaker audiovisual advertisement or related data. The MSD resident software program then inquires 635 whether the MSD user wishes to purchase the inquired product or service. If negative, the MSD resident software program ends 636, otherwise it continues by inquiring the MSD user's desired form of payment 637 and delivery 638, and it then ends 639.

If the MSD use desires to carry out a purchase 640, the MSD resident software program will inquire from the MSD user whether it would be utilizing an existing purchase list 650 or capturing a new label 660. If the first, the MSD resident software program will enable editing functions to modify the purchase list 651 before actually transacting the purchase. If the MSD user wishes to capture a label 660, the MSD resident software program will prompt the video capturing means of the MSD and inform the user that it is ready to capture a label. The MSD display screen may show a preview of the label for user approval in a graphic representation of a viewfinder. If the label captured is acceptable to the MSD resident software program 661 it will continue with the next step, otherwise, it will inform the MSD user of the capture failure and request a new label capture. Once the MSD resident software program satisfactorily deciphers the captured image and identifies it as a bar code label, it begins exchanging information with a remote server 671, utilizing preferably the data channel of the cellular communications network. The remote server authenticates the MSD, processes the data received from the MSD, responds to the MSD requests, and sends formatting instructions to the MSD such that the resident software program may format the MSD display screen according to its specific capabilities, including partitioning it into one or more windows. The remote server then sends to one of these windows the MSD user'requested information 672, and it may send to another window and to the device's speaker audiovisual advertisement or related data. The MSD resident software program confirms the MSD user purchase and prompts the user to select payment 673 and delivery options 674, which it sends to the remote server, and it then ends 675.

We claim:

1. A method for placing a purchase order with a merchant, the method comprising:
employing a mobile station device equipped with a label capturing means;
activating a software program resident in the mobile station device, the software program capable of operating the label capturing means, communication functions of the mobile station device, interfacing with a user, and processing a captured label;
selecting at least one merchant from a list of merchants offered by the software program;
entering user information and preferences in response to the software program requests;
capturing a label utilizing the label capturing means of the mobile station device;
the software program validating and identifying the captured label;
the software program generating a stream of data, the stream of data containing the identity of the mobile station device, the validated and identified captured label, and the user information and preferences;
communicating the stream of data between the mobile station device and a remote server via a communications network;
the remote server authenticating the stream of data, identifying the mobile station device, processing the user information and preferences, placing a purchase order with at least one merchant remote server, sending the mobile station device formatting instructions for its display screen, sending the mobile station device a merchant response to the purchase order, sending the mobile station device audio and visual data related to the purchase order;
the software program formatting the display screen of the mobile station device according to the remote server's formatting instructions, displaying the visual data received from the remote server through the display screen of the mobile station device, channeling the audio data received from the remote server through at least one mobile station device speaker.

2. The method of claim 1 wherein the label capturing means is at least one selected from a group consisting of a video camera, a laser scanner, an infrared receiver, and a radio frequency receiver.

3. The method of claim 1 wherein the communicating the stream of data takes place through at least one communication channel selected from a group consisting of control, voice, and data channels, of a cellular communications network.

4. The method of claim 1 wherein the label is a label selected from a group consisting of a standard bar code label, a proprietary bar code label, and a radio frequency label.

5. The method of claim 1 wherein the user preferences includes a selection of a form of payment and a form of delivery from a list offered by the selected at least one merchant that includes at least one form of payment and at least one form of delivery.

6. The method of claim 1 wherein the mobile station device is one selected from a group consisting of a cellular phone, a personal display assistant, an electronics organize, and internet appliance, a wristwatch, and a combination of two or more of this group.

7. The method of claim 1 wherein the communications network is one selected from a group consisting of a cellular communications network, a satellite communications network, a radio frequency communications network in a plurality of spectra, an infrared communications network, a wireless network, and a mobile station to mobile station communications network.

8. A method for placing an inquiry with a merchant, the method comprising:
employing a mobile station device equipped with a label capturing means;
activating a software program resident in the mobile station device, the software program capable of operating the label capturing means, communication functions of the mobile station device, interfacing with a user, and processing a captured label;
selecting from the software program one inquiry method from a group consisting of capture a label then find at least one merchant and having selected at least one merchant then capture a label;
having selected capture a label then find at least one merchant then, capturing a label utilizing the label capturing means of the mobile station device;
the software program validating and identifying the captured label;
entering user information and preferences in response to the software program requests;
the software program generating a stream of data, the stream of data containing the identity of the mobile station device, the validated and identified captured label, and the user information and preferences;
communicating the stream of data between the mobile station device and a remote server via a communications network;
the remote server authenticating the stream of data, identifying the mobile station device, processing the user information and preferences, placing an inquiry with the at least one merchant remote server, sending the mobile station device formatting instructions for its display screen, sending the mobile station device at least one merchant remote server response, sending the mobile station device audio and visual data related to the inquiry;
the software program formatting the display screen of the mobile station device according to the remote server's formatting instructions, displaying the at least one merchant remote server response and the visual data received from the remote server through the display screen of the mobile station device, channeling the audio data received from the remote server through at least one mobile station device speaker;
having selected at least one merchant then capture a label, selecting a merchant from a list of merchants offered by the software program;
capturing a label utilizing the label capturing means of the mobile station device;
the software program validating and identifying the captured label;
entering user information and preferences in response to the software program requests;
the software program generating a stream of data, the stream of data containing the identity of the mobile station device, the validated and identified captured label, and the user information and preferences;
communicating the stream of data between the mobile station device and a remote server via a communications network;
the remote serve authenticating the stream of data, identifying the mobile station device, processing the user information and preferences, placing an inquiry with the selected merchant remote server, sending the mobile station device formatting instructions for its display screen, sending the mobile station device the selected merchant remote server response, sending the mobile station device audio and visual data related to the inquiry;
the software program formatting the display screen of the mobile station device according to the remote server's formatting instructions, displaying the selected merchant remote server response and the visual data received from the remote server through the display screen of the mobile station device, channeling the audio data received from the remote server through at least one mobile station device speaker.

9. The method of claim 8 wherein the label capturing means is at least one selected from a group consisting of a video camera, a laser scanner, an infrared receiver, and a radio frequency receivers.

10. The method of claim 8 wherein the communicating the stream of data takes place through at least one communication channel selected from a group consisting of control, voice, and data channels, of a cellular communications network.

11. The method of claim 8 wherein the label is a one selected from a group consisting of a bar code label, a proprietary bar code label, and a radio frequency label.

12. The method of claim 8 wherein the mobile station device is one selected from a group consisting of a cellular phone, a personal display assistant, an electronics organizer, and internet appliance, a wristwatch, and a combination of two or more of this group.

13. The method of claim 8 wherein the communications network is one selected from a group consisting of a cellular communications network, a satellite communications network, a radio frequency communications network in a plurality of spectra, an infrared communications network, a wireless network, and a mobile station to mobile station communications network.

14. A method to induce a purchase comprising:
utilizing a remote server with data storage, data processing, and communications capabilities;
connecting the remote server to a communications network and retrieving, from at least one third party server, promotional information;
the remote server determining a triggering event whereby the promotional information may be used;
upon happening of the triggering event, the remote server generating a data stream containing the promotional information and audiovisual formatting instructions for a predetermined mobile station device;
the predetermined mobile station device having data storage, and data processing, communications capabilities, running a software program;
the remote server establishing a communications channel with the predetermined mobile station device;
the remote server communicating the data stream to the predetermined mobile station device;
utilizing the software program, resident in the predetermined mobile station device to communicate with the remote server and to process the data stream;
the software program formatting the predetermined mobile station device display screen and speaker according to the remote server's audiovisual formatting instructions;
the software program channeling the audiovisual promotional information to the formatted display screen and speaker of the predetermined mobile station device;
the software program requesting a user of the predetermined mobile station device an input in response to the audiovisual promotional information;
the software program processing and communicating the user's input to the remote server;
the remote server fulfilling the user's input with the at least one third party server.

15. The method of claim 14 wherein the communications channel established is at least one selected from a group consisting of control channel, voice channel, data channel, infrared channel, WiFi channel, and Bluetooth channel of a cellular communications network.

16. The method of claim 14 wherein the triggering event is the proximity of the predetermined mobile station device to a merchant's place of business.

17. The method of claim 14 wherein the user's input includes a request for comparative information, previously obtained discount promotions.

18. The method of claim 14 wherein the formatted display screen is partitioned into at least one window.
